(19) United States
(12) Patent Application Publication
(10) Pub. No.: US 2012/0243483 A1
(43) Pub. Date: Sep. 27, 2012

(54) WIRELESS COMMUNICATIONS DEVICE HAVING A VIRTUAL WIDEBAND CHANNEL

(76) Inventors: Sassan Ahmadi, Portland, OR (US); Muthaiah Venkatachalam, Beaverton, OR (US); Hujun Yin, San Jose, CA (US)

(21) Appl. No.: 13/228,116

(22) Filed: Sep. 8, 2011

Related U.S. Application Data
(63) Continuation of application No. 11/688,831, filed on Mar. 20, 2007, now abandoned.

(51) Int. Cl. H04W 72/04; H04W 68/00; H04W 56/00

(52) U.S. Cl. 370/329

(57) ABSTRACT

An embodiment of the present invention provides an apparatus comprising an Orthogonal

Frequency Division Multiple Access (OFDMA) wireless communication device having a virtual wideband channel comprising a single Media Access Control (MAC) layer instance coupled to first and second transport channels and at least one physical layer configured to communicate via first and second physical channels having a defined bandwidth. The first and second physical channels are mapped to the first and second transport channels, respectively, and are aggregated in the single MAC layer instance to provide a virtual wideband channel for the wireless communication device.

### CLAIM OF PRIORITY

This is a continuation of U.S. patent application Ser. No. 11/688,831 filed on Mar. 20, 2007, which is herein incorporated by reference in its entirety.

### BACKGROUND

The Institute for Electronic and Electrical Engineers (IEEE) 802.16e-2005 standard is an amendment to IEEE 802.16-2004. This amendment adds features and attributes to IEEE 802.16-2004 that are necessary for the support of mobility. The structure of medium access control (MAC) of IEEE 802.16e and its predecessors is based on Data-Over-Cable Service Interface Specification (DOCSIS - a cable modem standard) that has not been originally designed and optimized for mobile applications. The MAC architecture of IEEE 802.16e-2005, while very flexible, has certain inefficiencies, overhead, and limitations due to message-based control/signaling protocol characteristics. Furthermore, the MAC and radio link control (RLC) functionalities and services have not been well structured in the specification and are extremely confusing.

Thus, there is a strong need to improve the structure of the MAC, to reduce the overhead, and increase the efficiency of the MAC in the IEEE STD 802.16e-2005, and its evolution IEEE 802.16m based systems. A virtual wideband RF channel concept (support of contiguous and non-contiguous bands in OFDMA and non-OFDMA wireless systems) is also described herein, from which all wireless communication systems and standards can benefit.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 illustrates the mapping of logical channels to physical channels for the IEEE STD 802.16e-2005 based embodiment of the present invention;

FIG. 2 illustrates the mapping of logical channels to transport/physical channels for an IEEE 802.16m based embodiment of the present invention;

FIG. 3 illustrates a proposed downlink Layer 2 structure for IEEE STD 802.16e-2005 and IEEE 802.16m based embodiment of the present invention;

FIG. 4 illustrates a proposed uplink Layer 2 structure for IEEE STD 802.16e-2005 and 802.16m based embodiment of the present invention;

FIG. 5 illustrates the mapping of the physical channels to physical resources for an IEEE STD 802.16e-2005 based embodiment of the present invention;

FIG. 6 illustrates mapping of the transport/physical channels to physical resources for IEEE 802.16m based embodiment of the present invention using a separate physical resource block for data traffic and dedicated control and signaling;

FIG. 7 illustrates mapping of the transport/physical channels to physical resources for 802.16m based embodiment of the present invention using embedded dedicated control and signaling;

FIG. 8 illustrates the mapping of the physical channels to physical resources for IEEE

STD 802.16e-2005 based embodiment of the present invention; and

FIG. 9 illustrates an embodiment of the present invention with a generalized logical and transport channel concept.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements. It must be noted that various embodiments/implementations of this invention may use different naming convention or may utilize partial or full set of logical/transport/physical channels defined herein.

### DETAILED DESCRIPTION

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Embodiments of the invention may be used in a variety of applications. Some embodiments of the invention may be used in conjunction with various devices and systems, for example, a transmitter, a receiver, a transceiver, a transmitter-receiver, a wireless communication station, a wireless communication device, a wireless Access Point (AP), a modem, a wireless modem, a Personal Computer (PC), a desktop computer, a mobile computer, a laptop computer, a notebook computer, a tablet computer, a server computer, a handheld computer, a handheld device, a Personal Digital Assistant (PDA) device, a handheld PDA device, a network, a wireless network, a Local Area Network (LAN), a Wireless LAN (WLAN), a Metropolitan Area Network (MAN), a Wireless MAN (WMAN), a Wide Area Network (WAN), or a Wireless WAN.

Although embodiments of the invention are not limited in this regard, discussions utilizing terms such as, for example, “processing,” “computing,” “calculating,” “determining,” “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and “a plurality” as used herein may include, for example, “multiple” or “two or more”. The terms “plurality” or “a plurality” may be used throughout the specification to describe two or more components, devices, elements, units, parameters, or the like. For example, “a plurality of stations” may include two or more stations.

Currently in mobile World Interoperability for Microwave Access (mobile WiMAX)/IEEE STD 802.16, the concept of logical and transport/physical channelization does not exist. Also the concept of transport channel groups for support of non-contiguous bands (virtual wide bandwidths) not only does not exist in IEEE 802.16, but also it does not exist in other cellular standards such as WCDMA, 3GPP LTE, and 3GPP2 AIE. Some embodiments of the present invention provide a mobile WiMAX friendly logical and transport/physical channel structure that may be used to enhance and structure MAC functionalities as well as to reduce the layer 2 (L2) overhead in the IEEE 802.16m/802.16 evolution standard. Furthermore, it would allow efficient support of non-contiguous bands through the use of transport channel groups to minimize the impacts to L2 and upper layers in the protocol stack. It is understood that the present invention is intended to be included in the IEEE 802.16m/802.16 evolution standard.

Currently, the MAC/RLC layers in cellular standards such as WCDMA, cdma2000, or GSM have been designed specifically for mobile applications and are structured such that the functionalities and services are well defined in terms of mappings from radio bearers to transport/physical channels. However, incorporation of this logical and transport/physical channel structure in the IEEE 802.16e evolution (i.e., IEEE 802.16m) based on some embodiments of the present invention have the following advantages:
It will provide a good and clear insight into functionalities of PHY and MAC protocols.
It will organize and structure different services provided by the MAC layer.
It will simplify classification, understanding, and simulation of different information transfer/management services provided by the MAC layer.
It will simplify mapping/multiplexing of various MAC services to the transport channels provided by the physical layer based on the type of information.
It will make comparison/harmonization of various 802.16e (and its evolution) MAC information/management services and functionalities with cellular MAC protocols more straightforward.
It is expected that the use of a well-designed logical channel structure could further result in increased efficiency and overhead reduction of the MAC and RLC layers.
The use of logical and transport/physical channel structure would allow efficient and low complexity support of non-contiguous transmission bandwidths (virtual wideband channels) that is the key to support wide channel bandwidths in the excess of 20 MHz by aggregation of smaller chunks of bandwidths.

It is noted that the definition of the logical and transport/physical channels will not affect the current standard. The mapping of logical and transport/physical channels to the existing and the evolved IEEE STD 802.16e-2005 standard (IEEE 802.16m) are provided in embodiments of the present invention.

Herein is provided an efficient and novel logical and transport/physical channelization scheme for the IEEE STD 802.16e-2005 and IEEE 802.16m and future broadband wireless radio access technologies. An embodiment of the present invention provides the transport/physical and logical mappings for the existing and extended systems. The concepts related to support of non-contiguous bands described in the present invention may be further utilized in other OFDMA and non-OFDMA cellular systems.

Consistent with other cellular standards such as 3GPP LTE and WCDMA, the following terminologies are defined and used throughout the present invention:

Logical Channel: The MAC sublayer provides data transfer services on logical channels. A set of logical channel types is defined for different types of data transfer services provided by the MAC layer. Each logical channel type is defined by what type of information is transferred. In other words, the SAPs between the MAC sublayer and the RLC sublayer provide the logical channels. Logical channels are classified into two groups:
Control/signaling channels for the transfer of control/signaling messages/information.
Traffic channels for the transfer of user data.

Physical Channel: A manifestation of physical resources (time, frequency, code, and space) that are used to transport data/control/signaling to/from a single user or a multitude of users.

Signaling Channel: Signaling channels are logical channels that are used for transfer of MAC signaling information/messages. They are used to setup or tear-down data bearers, ACK/NACK signaling, etc.

Control Channel: Control channels are logical channels that are used for transfer of MAC control information/messages. They are used to control data bearer parameters.

Traffic Channel: Traffic channels are logical downlink/uplink channels that are used for the transport of unicast/multicast data flows (user traffic).

Access Channel: An access channel is a physical uplink channel that is used for initial access to the system through contention or polling.

Multicast Channel: A point-to-multipoint physical/logical downlink channel for transporting multicast data/control/signaling.

Unicast Channel: A point-to-point physical/logical channel for transporting data/control/signaling to a specific user in the cell.

Shared Channel: A point-to-point or point-to-multipoint bi-directional physical channel that is shared/multiplexed through TDM, FDM, CDM, SDM schemes or combination of the above among a multitude of users.

Common Channel: A point-to-multipoint unidirectional logical channel conveying signaling/control messages/information to all users in the coverage area of a BS. The user does not have to register with the BS in order to receive the common channel (i.e., no RRC connection is needed).

Broadcast Channel: The primary purpose of the broadcast transport channel is to broadcast a certain set of cell or system specific information to all users in the coverage area of a BS. The user does not have to register with the BS in order to receive the broadcast channel.

Dedicated Channel: A point-to-point transport/physical or logical channel that transports user specific data/control/signaling messages/information.

Service Access Point (SAP): The point in a protocol stack where the services of a lower layer are available to its next higher layer.

Transport Channel: The SAP between the physical layer and the MAC sublayer provides the transport channels. A transport channel is defined by how and with what characteristics data is transferred over the air interface. There exist two types of transport channels:
Dedicated channels
Common channels

Radio Bearer: The SAP between the RLC sublayer and the convergence sublayer provide the radio bearers.

It is noted that generally in Orthogonal Frequency-Division Multiple Access (OFDMA) systems, the transport and physical channels are identical (a one-to-one mapping) and this is the assumption in some embodiments of the present invention, although the present invention is not limited in this respect. However, the support of non-contiguous bands or aggregation of smaller bandwidths to virtually create a wider bandwidth requires an appropriate mapping of the transport channels to physical channels (i.e., different physical layers and their corresponding physical resources) so that a single MAC layer, herein called a super-MAC, represented by a set of logical channels may be mapped to those transport channels. In this case, the transport channels are not identical to physical channels.

Thus, as used in describing embodiments of the present invention “transport/physical” nomenclature is used for the cases where transport and physical channels are identical and one-to-one mapped; and separate transport and physical channel mapping terminology is used wherever it applies.

Based on the above definitions, a number of logical and transport/physical channels are defined that may appropriately describe the existing and future functionalities of the 802.16e and 802.16m standards. The following contains the acronyms and their descriptions. To define the logical and transport/physical channels, first all functions and services of MAC and RLC layers have been identified and classified. Then depending on the functional classes, various channels are defined that map the radio bearers to the transport/physical channels. It is noted that based on the definition of a transport channel herein, the current 802.16e standard does not support any transport channel and transport channels are identical to physical channels. However, for the next generation of the standard, it is possible to define transport channels, whose mapping to physical channels need to be specified.

Acronym Definition

PSCH Primary Synchronization Channel: This is the legacy preamble that is located at the first OFDM symbol of every frame and used for timing, frequency, and cell ID acquisition

SSCH Secondary Synchronization Channel: This is a robust supplemental preamble that is added to improve the cell selection and system acquisition by the new terminals. The position of the supplemental preamble is fixed (i.e., the first sub-frame of the first frame within a super-frame) to ensure a fixed system timing. It repeats once per superframe.

CONFIG-CH Configuration Channel: This broadcast channel contains a set of cell or system specific configuration information. In the current IEEE STD 802.16e-2005 this channel is corresponding to FCH (describing the MAP) and DCD and UCD that follow the DL/UL MAP.

MAP-CH Medium Access Protocol Channel: This broadcast logical channel represents the IEEE STD 802.16e-2005 MAP which contains information on burst allocation and physical layer control message (IE: Information Element)

CCSCH Common Control and Signaling Channel: This logical channel corresponds to the IEEE STD 802.16e-2005 broadcast CID to be used at the MAC layer for paging etc.

MBS-PICH Multicast Broadcast Pilot Channel: A common pilot channel that facilitates combing during multi-BS MBS SFN operation.

CPICH Common Pilot Channel: A common channel that contains reference signals to be used by terminals during periods of time with no dedicated channel assignment in order to stay synchronous with the system.

PICCH Pilot Control Channel: A dedicated control channel that conveys commands to control the density of the secondary pilots in the basic resource block (The pilot density is adapted to the mobility region, antenna configuration, etc.).

DL-SCH Downlink Shared Channel: A physical channel comprising time, frequency, code, and/or space resources that are used to transport the data/control/signaling messages/information in the downlink.

UL-SCH Uplink Shared Channel: A physical channel comprising time, frequency, code, and/or space resources that are used to transport the data/control/signaling messages/information in the uplink.

MBS-SCH Multicast Broadcast Shared Channel: A point-to-multipoint downlink physical channel that is used to transport MBS traffic.

DL-PPICH Downlink Primary Pilot Channel: A dedicated downlink physical channel containing the primary dedicated reference signals within a basic resource block. The position of these pilots may be rotated according to a pre-determined pattern.

UL-PPICH Uplink Primary Pilot Channel: A dedicated uplink physical channel containing the primary dedicated reference signals within a basic resource block. The position of these pilots may be rotated according to a pre-determined pattern.

DL-SPICH Downlink Secondary Pilot Channel: A dedicated downlink physical channel containing the secondary (supplemental) dedicated reference signals within a basic resource block. The position of these pilots may be rotated according to a pre-determined pattern. The additional pilots are used to support multiple TX antennas and higher motilities.

UL-SPICH Uplink Secondary Pilot Channel: A dedicated uplink physical channel containing the secondary (supplemental) dedicated reference signals within a basic resource block. The position of these pilots may be rotated according to a pre-determined pattern. The additional pilots are used to support multiple TX antennas and higher motilities.

CQICH Channel Quality Indicator Channel: A dedicated physical channel on the uplink for reporting channel state information by the mobile stations.

DL-ACKCH Downlink Acknowledge Channel: A dedicated physical channel to transport H-ARQ ACK/NACK signaling on the downlink.

UL-ACKCH Uplink Acknowledge Channel: A dedicated physical channel to transport H-ARQ ACK/NACK signaling on the uplink.

DL-TCH Downlink Traffic Channel: A dedicated downlink logical channel for transporting user data traffic. It is known as DL data CID in IEEE STD 802.16e-2005.

UL-TCH Uplink Traffic Channel: A dedicated uplink logical channel for transporting user data traffic. It is known as UL data CID in IEEE STD 802.16e-2005.

QACH Quick Access Channel: An uplink contention-based physical channel for quick system re-entry (contention-based BW-REQ). It can be used for bandwidth request and potentially for low-rate data transmission prior to traffic channel assignment.

MBS-TCH Multicast Traffic Channel: A common down-link logical channel for transporting MBS traffic (MBS CIDs).

MBS-MAP-CH Multicast Broadcast MAP Channel: A common down-link logical channel for transporting MBS MAP.

DL-DCSCH Downlink Dedicated Control and Signaling Channel: A point-to-point logical channel that conveys signaling information to a specific user that includes basic CIDs as well as signaling for handoff and MS state transition.

UL-DCSCH Uplink Dedicated Control and Signaling Channel: A point-to-point logical channel that conveys signaling information to a specific user that includes basic CIDs as well as signaling mobility regions (refer to Doppler frequency based mobility adaptation).

PCH Paging Channel: A logical channel that is used to broadcast paging messages to the users. It will further include Traffic Indicators.

PER-RNG-CH Periodic Ranging Channel: A physical contention-based uplink channel to be used by mobile stations to perform periodic frequency, time, and power adjustments.

INI-RNG-CH Initial Ranging Channel: A physical contention-based uplink channel that is used by the mobile stations to perform closed-loop time, frequency, and power adjustments as well as bandwidth request.

Based on the above definitions, the logical and transport/physical channels according to this invention can be defined and classified as follows (shown in the table below):

| | | | |
|---|---|---|---|
| Transport/ | Dedicated | Traffic/Access | DL-SCH, UL-SCH |
| Physical | Channels | Channels | (Unicast Traffic) |
| Channels | | Control/Signaling | DL-PPICH, UL-PPICH |
| | | Channels | DL-SPICH, UL-SPICH |
| | | | DL-ACKCH, UL-ACKCH |
| | | | CQICH |
| | Common | Traffic/Access | INI-RNG-CH (UL ONLY), |
| | Channels | Channels | QACH (UL ONLY), MBS- |
| | | | SCH |
| | | Control/Signaling | PSCH, SSCH |
| | | Channels | PER-RNG-CH (UL ONLY) |
| | | | CONFIG-CH (DL ONLY), |
| | | | PCH (DL ONLY) |
| | | | CPICH (DL ONLY), MBS- |
| | | | PICH (DL ONLY) |
| Logical | Dedicated | Traffic/Access | DL-TCH, UL-TCH |
| Channels | Channels | Channels | |
| | | Control/Signaling | DL-DCSCH, UL-DCSCH |
| | | Channels | |
| | Common | Traffic/Access | MBS-TCH (DL ONLY) |
| | Channels | Channels | |
| | | Control/Signaling | CCSCH, MBS-MAP-CH, |
| | | Channels | MAP-CH PICCH |

Therefore, each logical and transport/physical channel can be further classified into dedicated or common channel depending on the characteristics of that channel. The common versus dedicated nature of each channel is decided based on the certain function of that channel and the definition of the dedicated and common channel provided earlier.

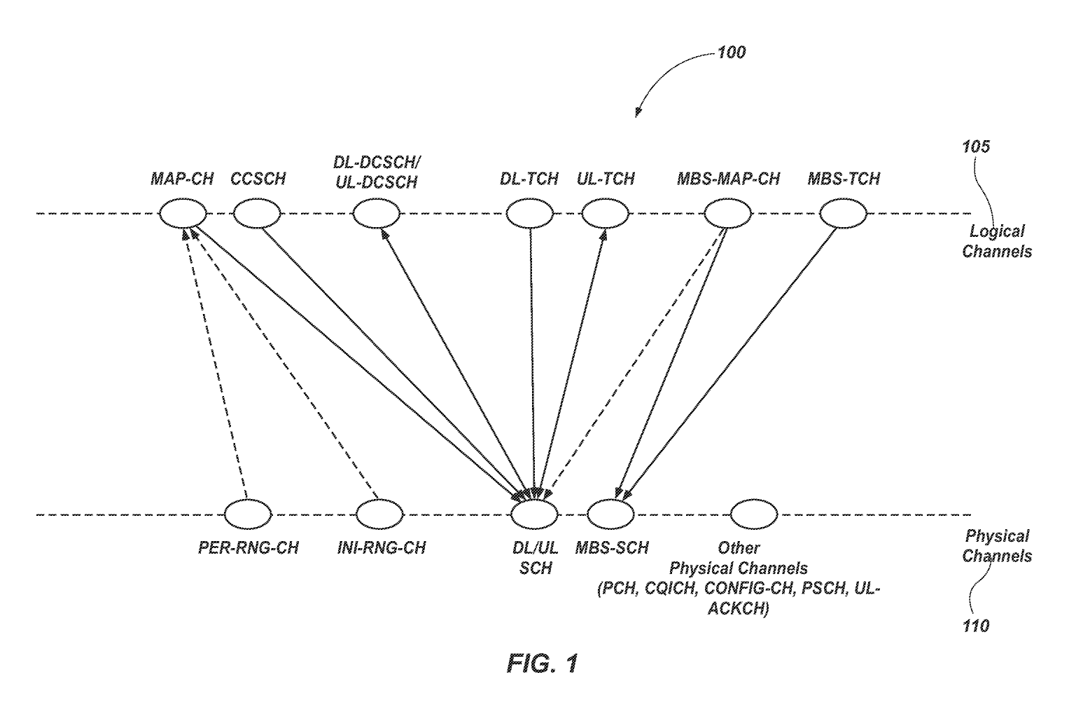

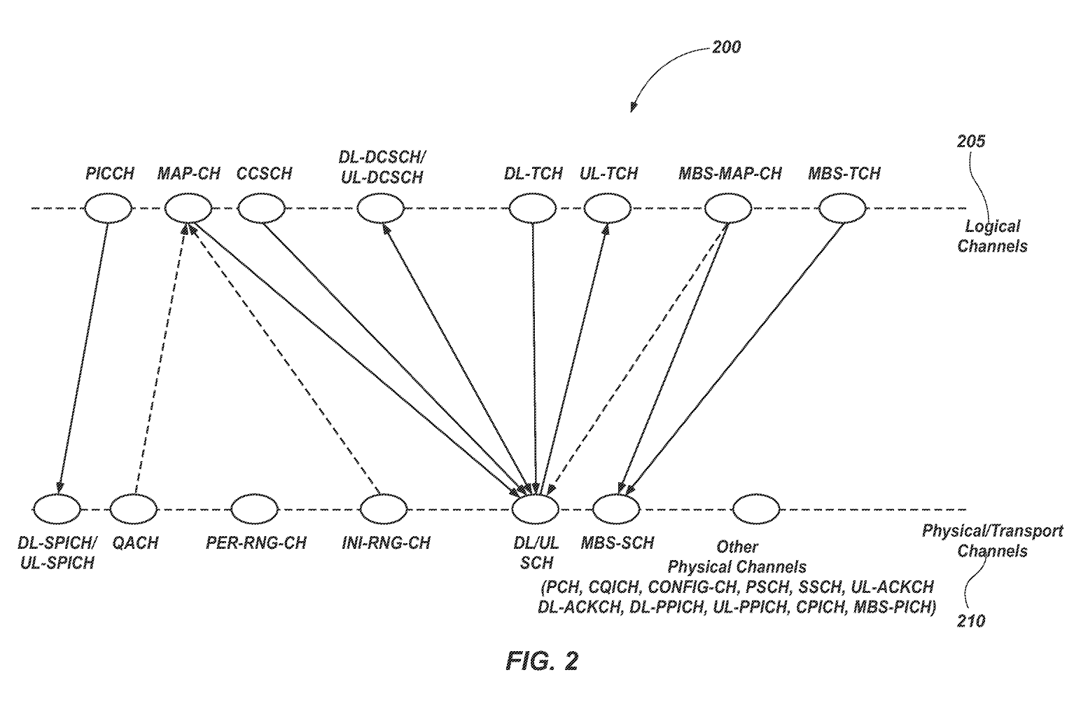

Turning now to the figures, FIG. 1 and FIG. 2, shown generally as 100 and 200, provide the mapping between logical and transport channels that can be applied to the existing standard and the future standard (i.e., IEEE 802.16m). FIG. 1 provides the mapping of logical channels 105 to physical channels 110 for IEEE STD 802.16e-2005 (current mobile WiMAX). FIG. 2 illustrates the mapping of logical channels 205 to transport/physical channels 210 for IEEE 802.16m standard (evolution of mobile WiMAX). Note that currently the notion of logical and transport/physical channel structure does not exist and has not been previously defined in the IEEE STD 802.16e-2005. Since IEEE 802.16m and future mobile WiMAX are expected to be backward compatible with all mandatory and a subset of optional IEEE STD 802.16e-2005 features, the support of certain (not all) IEEE STD 802.16e-2005 MAC and RLC is mandatory. Thus, when the new standard is drafted; the logical and transport/physical channelization may be further applied to legacy features without impacting the interoperability and backward compatibility with the legacy systems and terminals. Of course, the new channelization and layer 2 structures may be applied to IEEE 802.16m standard (and subsequently to future mobile WiMAX).

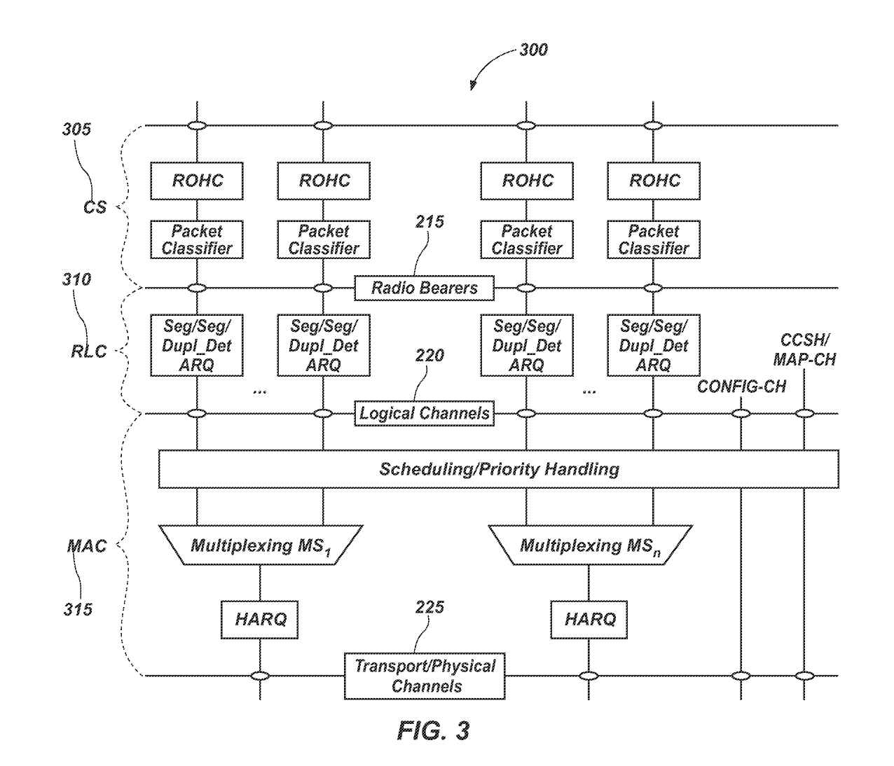

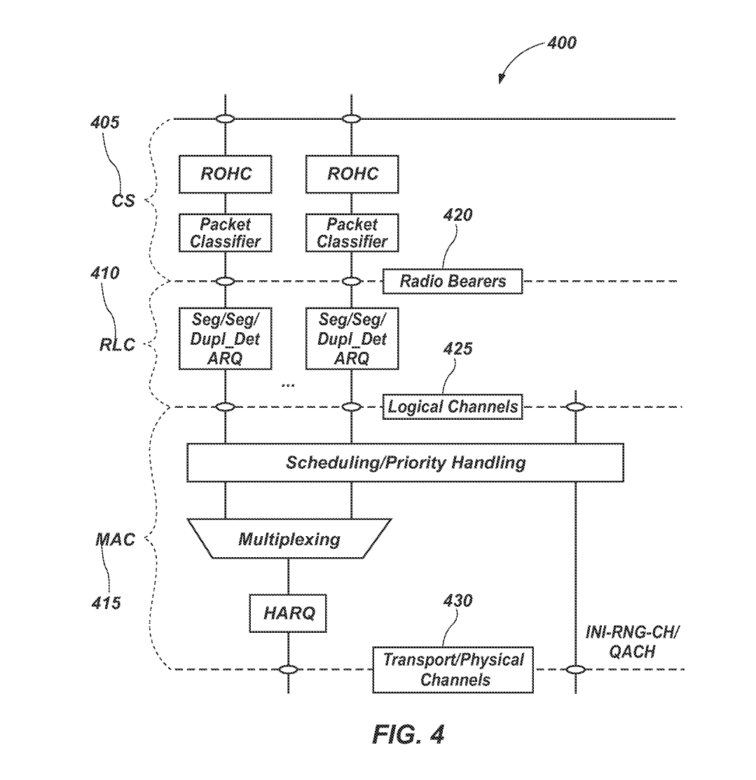

Looking now at FIGS. 3 and 4, when one studies the various functions of the MAC 315 and 415, RLC 310 and 410, and CS (convergence sub-layer) 305 and 405, one would conclude that there are stratum/layers of functions/services between the network layer and the physical layer that are collectively and commonly referred to as a data link layer. Consistent with other cellular standards and coherent with the characteristics and type of services provided by IEEE STD 802.16e-2005 MAC 315 and RLC 310, an embodiment of the present invention provides that the functionalities of these layers be structured as shown as 300 and 400 of FIG. 3 and FIG. 4 wherein the downlink (at base station) and uplink (at the mobile station) to increase clarity of definition of services and to improve efficiency of these services through an architecture has been tested for many years in other cellular standards. Specifically FIG. 3 illustrates the proposed downlink layer 2 structure for IEEE STD 802.16e-2005 and IEEE 802.16m with transport/physical channels 325, logical channels 320 and radio bearers 315 and FIG. 4 shows the uplink layer 2 structure for IEEE STD 802.16e-2005 and IEEE 802.16m of an embodiment of the present invention with transport/physical channels 430, logical channels 425 and radio bearers 420.

It must be noted that although this structure is a general structure that has been seen in the literature, the specifics of IEEE STD 802.16e-2005 and future IEEE 802.16m has been added to the proposed structure to customize the structure for the exiting and the future IEEE STD 802.16e-2005 (and IEEE 802.16m) based systems. Note that the convergence layer (CS) layer in IEEE STD 802.16e-2005 does not include any ciphering function which makes it different from that of 3GPP LTE systems.

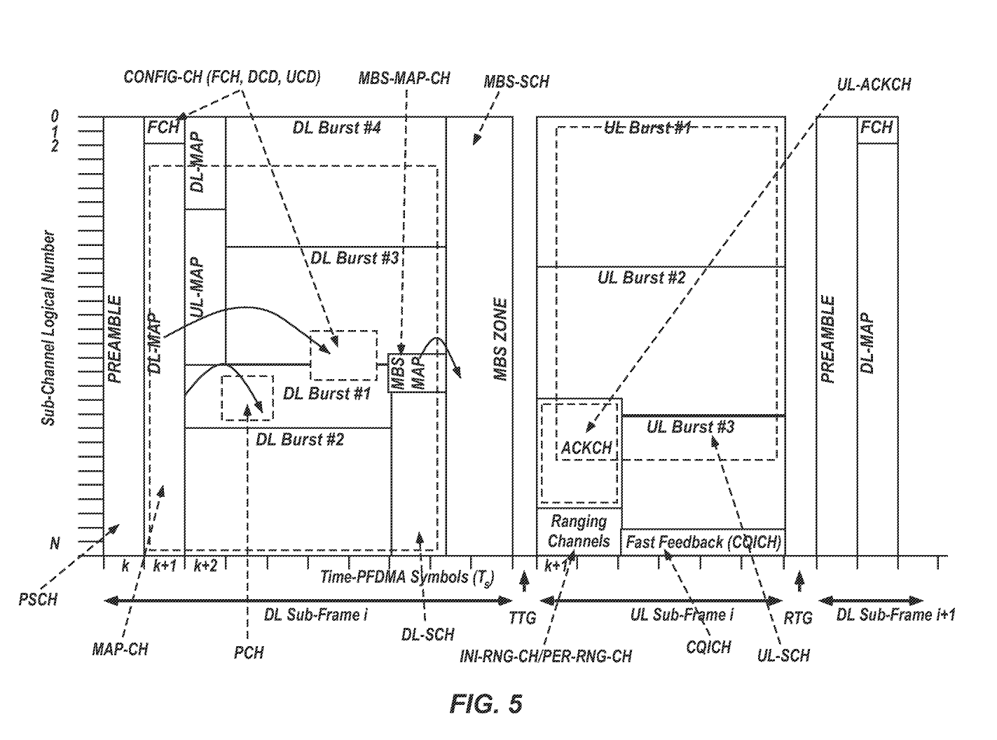

To further depict how the proposed physical channels may be applied to the existing standard, the mapping of the physical channels to IEEE STD 802.16e-2005 physical resources is shown at 500 of FIG. 5. Note that not all physical channels defined here are applicable to the IEEE STD 802.16e-2005. It must be noted that the application and mapping of the physical and logical channels for the existing standard, does not impact the interoperability with the legacy systems and terminals that only understand and support IEEE STD 802.16e-2005.

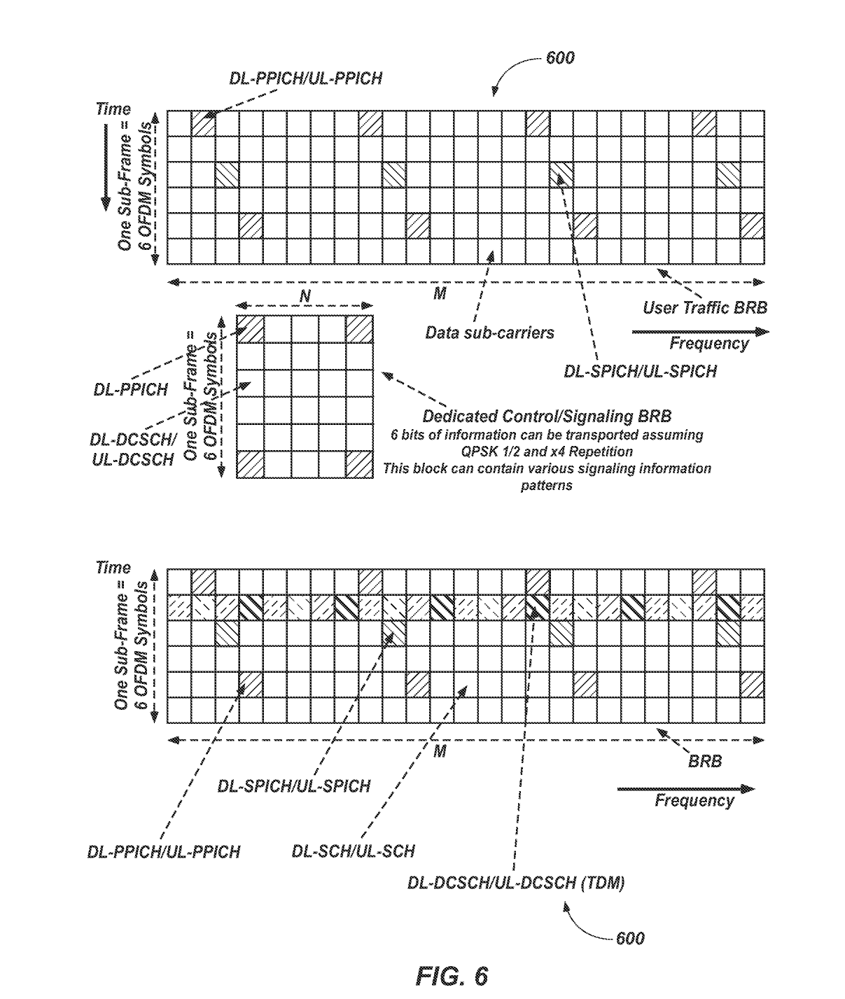

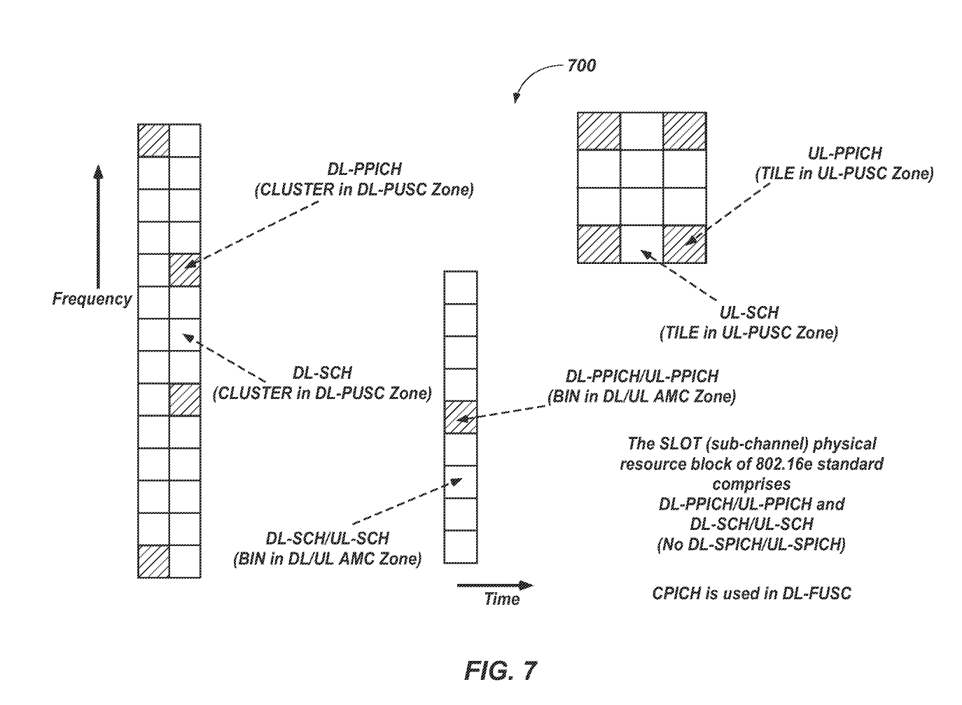

The mapping of the transport/physical channels to the physical resources in IEEE 802.16m standard (under development) is shown in FIGS. 6 at 600 and 610 and FIG. 7 at 700. Since there is an attempt to define new physical resources in IEEE 802.16m standard while maintaining backward compatibility through the use of a new frame structure, two possible options for enabling dedicated control and signaling is illustrated. The DL-SPICH and UL-SPICH are controlled through PICCH that is a new MAC functionality. The density of the secondary pilots shall be controlled based on mobility, antenna configuration (number of transmit antennas), etc.

For the mapping of the dedicated control and signaling channels in IEEE 802.16m, two methods are proposed and may be used. In the first option shown in FIG. 6 at 600, two separate physical resource blocks are defined for the control/signaling and data traffic. The size of the control/signaling block is naturally smaller than the data resource block. It is understood that the sizes shown in FIGS. 6 and 7 are examples and do not limit the scope of the present invention.

Note that the present invention does not have any preference with respect to any of these options and the intent is to show how transport/physical channels are mapped to actual physical resources. In FIG. 6 at 610 is illustrated mapping of the transport/physical channels to physical resources for IEEE 802.16m using embedded dedicated control and signaling.

Also the mapping of some physical channels to the physical resource blocks (slots) that are currently available in the mobile WiMAX or IEEE STD 802.16e-2005 are shown at 700 of FIG. 7 and may depend on the type of DL or UL permutation. An advantage of the proposed structure of FIG. 7 of an embodiment of the present invention is the hierarchy and organization that it is established through the present invention may ultimately make the MAC and RLC functions of IEEE 802.16m and mobile WiMAX as efficient as (or more efficient than) other cellular standards for support of mobile applications.

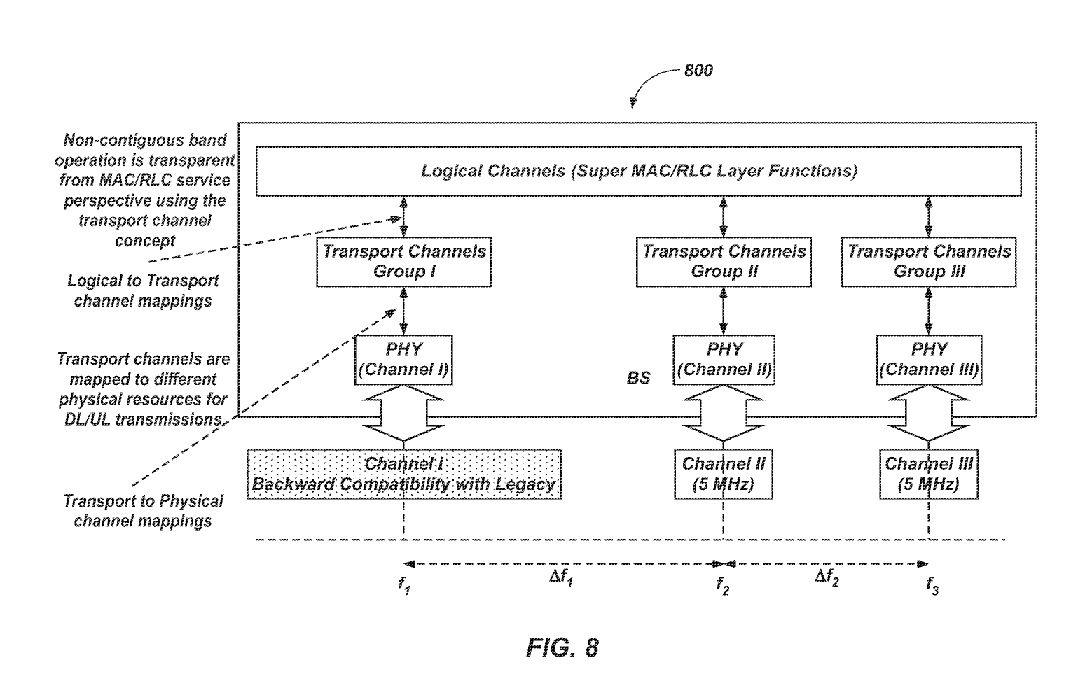

Looking now at FIG. 8, generally as 800, is an embodiment of the present invention that may also provide a “Super” MAC and Generalized Transport Channel concept for support of Non-Contiguous RF channels. The logical and transport channelization concept described above may be further generalized to enable support of non-contiguous spectrum.

If the available spectrum for a BW MHz deployment consists of a number of bands BWi where

$$BW = {\sum }_{i = 1}^{N} {BW}_{i}$$

and the spectrum partitions are separated by Δfᵢ=fᵢ−f_{i +1} then one efficient method for support of such scenarios with minimal impact to upper layers (i.e., MAC and above) is to define a group of transport channels and map each group to a physical layer that corresponds to center frequency/transmission bandwidth set (fᵢ, BWᵢ). In this case, only the group of transport channels is seen by the MAC layer (whose functionalities are represented by the logical channels). Therefore, a virtual wideband system is created through aggregation of smaller bandwidths with minimal impacts (ideally no impacts) to the L2 and above. To make the system operation more efficient the following fundamental assumptions are considered:
Synchronization and broadcast channels shall be transmitted on all channels (to enable system acquisition for mobile stations attached at different frequencies);
Common control/signaling channels may be separated (corresponding to each transport channel group);
A minimum channel bandwidth must be specified (BWₘᵢₙ). Here we assume that the minimum channel bandwidth is 5 MHz;
There can be a mixture of mobile stations with 5 or 10 MHz bandwidth (according to this example) capability supported in the system;
The non-contiguous band operation shall be transparent from MS perspective.
Paging messages are sent on different channels depending on the transport channel group to which the mobile stations are attached; and
DL/UL traffic and control channels for each transport group are different as shown below.

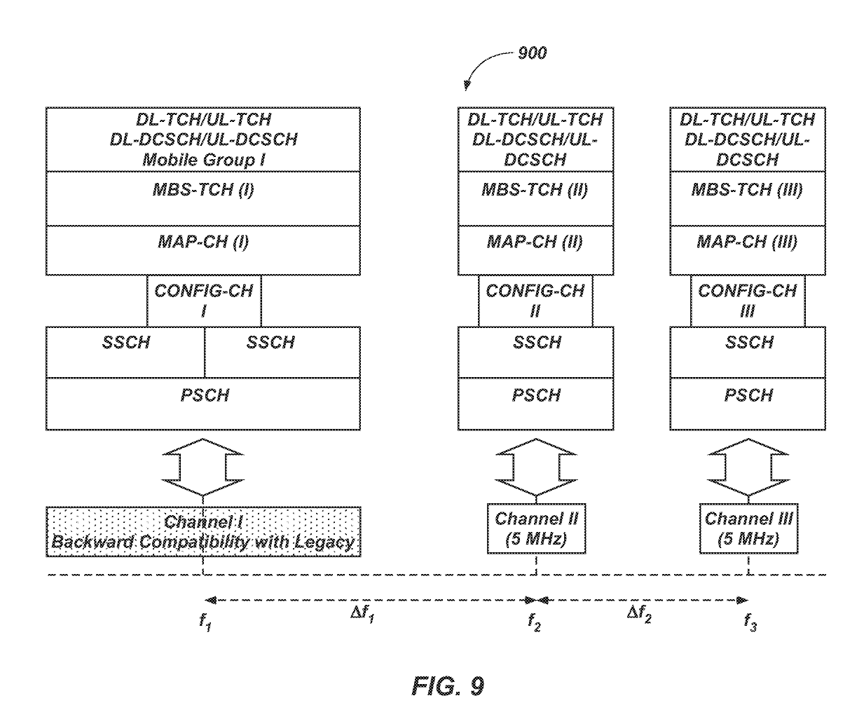

FIG. 9 at 900 shows an example of transport channel group mappings for the scenario described above, although the present invention is not limited in this respect. The broadcast and multicast transport channels may be the same or different among the transport channel groups. In FIG. 9 the mapping of the transport channel groups to different physical layers corresponding to different carriers are illustrated. Depending on the distribution of physical resources in time and frequency domains (and possibly in spatial domain) and across different RF carriers (bands), the mapping of the transport channel groups to physical channels may be appropriately designed.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claimed is:

1. A method for mapping multiple physical channels in a wireless communication device, comprising:
defining a first transport channel and a second transport channel coupled to a single Media Access Control (MAC) instance in a wireless communication device configured to communicate using Orthogonal Frequency-Division Multiple Access (OFDMA);
mapping the first and second transport channels to a selected first physical channel having a first defined bandwidth and a selected second physical channel having a second defined bandwidth, respectively, wherein the first and second physical channels are respectively associated with at least one physical layer of the wireless communication device; and
aggregating the defined bandwidths of the first physical channel and the second physical channel in the single MAC layer instance to form a virtual wideband channel for the wireless communication device.

2. The method of claim 1, wherein defining the first and second transport channels further comprises defining the first and second transport channels, wherein the wireless communication device is at least one of a base station and a mobile wireless device configured to communicate with the base station via the virtual wideband channel.

3. The method of claim 1, wherein the first physical channel has a defined bandwidth that is not contiguous with a defined bandwidth of the second physical channel.

4. The method of claim 1, wherein the first physical channel has a defined bandwidth that is contiguous with a defined bandwidth of the second physical channel.

5. The method of claim 1, further comprising transmitting a synchronization channel and a broadcast channel on all physical channels.

6. The method of claim 1, further comprising defining the first transport channel and the second transport channel as at least one of a dedicated transport channel and a common transport channel.

7. The method of claim 1, further comprising defining the first transport channel and the second transport channel as a service access point between the at least one physical layer and the single Media Access Control (MAC) instance in the wireless communication device.

8. The method of claim 1, wherein defining the first transport channel and the second transport channel further comprises defining a first transport channel group and a second transport channel group, wherein each transport channel group includes at least one channel selected from the group consisting of a control channel, a signaling channel, a traffic channel, an access channel, a multicast channel, a unicast channel, a shared channel, a common channel, a broadcast channel, a dedicated channel, and a sync channel.

9. The method of claim 1, further comprising communicating paging messages from one of the first physical channel and the second physical channel at a base station, wherein one of the first and second physical channels is selected to communicate the paging messages based on which of the first and second physical channels a mobile communication device is in communication with.

10. The method of claim 1, further comprising:
defining a plurality of transport channels coupled to the single MAC instance in the wireless communication device;
mapping the plurality of transport channels to a plurality of physical channels, respectively, with each physical channel having a defined bandwidth in the at least one physical layer of the wireless communication device; and
aggregating the defined bandwidths of the plurality of physical channels in the single MAC layer instance to form a virtual wideband channel for the wireless communication device.

11. The method of claim 1, further comprising mapping the first and second transport channels to the first and second physical channels, respectively, based on a distribution of physical resources in at least one of a time domain, a frequency domain, and a spatial domain.

12. The method of claim 1, wherein the wireless communication device is configured to operate using at least one standard selected from the group consisting of IEEE 802.16e-2005, IEEE 802.16m, and 3GPP LTE.

13. A wireless communication device having a virtual wideband channel, comprising:
a single Media Access Control (MAC) layer instance in the wireless device coupled to a first transport channel and a second transport channel, wherein the wireless communication device is configured to communicate using Orthogonal Frequency-Division Multiple Access (OFDMA);
at least one physical layer configured to communicate via a first physical channel having a defined bandwidth and a second physical channel having a defined bandwidth;
wherein the first and second physical channels are mapped to the first and second virtual channels, respectively, and are aggregated in the single MAC layer instance to provide a virtual wideband channel for the wireless communication device.

14. The system of claim 13, wherein each physical channel has a predetermined bandwidth.

15. The system of claim 13, wherein the first and second physical channels each have a defined bandwidth that is at least one of contiguous and non-contiguous.

16. The system of claim 13, wherein the first transport channel and the second transport channel each comprise a service access point between the at least one physical layer and the single MAC instance in the wireless communication device.

17. The system of claim 13, wherein the first physical channel and the second physical channel have different bandwidths.

18. The system of claim 13, wherein the physical layer is configured to communicate via a plurality of physical channels that each have a defined bandwidth.

19. The system of claim 18, wherein the single MAC layer instance is coupled to a separate transport channel for each of the plurality of physical channels and aggregates the defined bandwidth of each of the plurality of physical channels to form the virtual wideband channel.

20. The system of claim 13, wherein the wireless communication device is configured to operate using at least one standard selected from the group consisting of IEEE 802.16e-2005, IEEE 802.16m, and 3GPP LTE.
